(19) United States
(12) Patent Application Publication
(10) Pub. No.: US 2025/0296090 A1
(43) Pub. Date: Sep. 25, 2025

(54) AUTONOMOUS MILL AND MILLING METHOD

(71) Applicant: Delica AG, Buchs (CH)

(72) Inventor: Joël CHIAPPARELLI, Eiken (CH)

(73) Assignee: Delica AG, Buchs (CH)

(21) Appl. No.: 18/863,186

(22) PCT Filed: May 4, 2023
(86) PCT No.: PCT/CH2023/050012

§ 371 Date: Nov. 5, 2024

(30) Foreign Application Priority Data
May 6, 2022 (CH) 000527/2022

(51) Int. Cl. B02C 4/32; B02C 4/02; B02C 25/00

(52) U.S. Cl. CPC B02C 4/32; B02C 4/02; B02C 25/00

(57) ABSTRACT

A mill comprising an inlet (1) for products (P) to be milled, at least one milling mechanism (2), an outlet (3) for the milled product (M), at least one particle measuring probe (4) for ascertaining the sizes of the particles running past the particle measuring probe, a control unit, and means for adjusting the milling mechanism (2). The at least one particle measuring probe (4) or a particle removing device which is connected to the particle measuring probe (4) via a suction device is arranged in the milling mechanism (2) or between the milling mechanism (2) and the outlet (3). The control unit is suitable for controlling the means for adjusting the milling mechanism (2) on the basis of information from the at least one particle measuring probe, in particular a size distribution ascertained on the basis of multiple measurements.

### FIELD OF THE INVENTION

The present invention relates to an autonomous mill for milling natural products and a milling method.

### BACKGROUND OF THE INVENTION

The purpose of a mill is to grind coarse material into a fine-grained end product, whereby the size of the ground particles is in many cases the decisive quality feature and thus the reference size of the milling process. In the mill, the coarse material is usually conveyed between rollers arranged in pairs. In the mill, the coarse material is usually conveyed between pairs of rollers, whereby the rollers of a pair of rollers are spaced apart with a certain roller gap. The particle size of the resulting ground material depends on the width of the roller gap and can be adjusted by moving the rollers closer together or further apart. In addition to the width of the roller gap, the ambient temperature, the temperature of the products to be ground, the pressure prevailing in the mill, the humidity, the moisture of the products to be ground, the speed of the rollers, the roller temperature and the vibrations prevailing in the mill can also have an influence on the quality of the ground material or provide information on the performance of the mill. To ensure the consistent quality of the ground material and the performance of the mill, it is known in the state of the art to measure these parameters during the milling process and adjust them to a predetermined target value. To monitor and adjust the particle size, ground material is typically extracted from the mill using a sampling scoop, the sample is then analysed in an external device and the mill settings are then adjusted depending on the measurement result. However, sampling represents a considerable repetitive effort and loss of material and the time delay caused by the external measurement does not allow efficient regulation and control of the mill settings. Certain mill manufacturers have therefore developed automatic measuring systems to determine and regulate the force distribution between the rollers in order to continuously adjust the particle size during the milling process. However, this method does not measure the particle size directly, but assumes that the force is proportional to the degree of milling, i.e. the particle size. This may well be the case for synthetic products, but certainly not for natural products, which usually have very non-uniform properties. For example, the hard-ness of coffee beans or wheat grains can vary greatly depending on the type of plant, place of cultivation, growing conditions and/or drying process, and the size of the particles ground by the rollers varies accordingly, even with identical force distribution between the rollers.

### SUMMARY OF THE INVENTION

The present invention now sets itself the task of providing a milling process and an autonomous mill which enables automatic, dynamic and fine adjustment of the particle size of the material to be ground during the milling process.

This task is solved by an autonomous mill with the features of the independent patent claim(s) and a milling method with the features of the independent patent claim(s). Further features and embodiments are shown in the dependent claims and their advantages are explained in the following description.

### BRIEF DESCRIPTION OF THE DRAWING(S)

The drawings show:

FIG. 1a Schematic representation of the mill according to the invention, side view in section

FIG. 1b Detailed view of the nip of a pair of rollers, side view in section

FIG. 1c Detailed view of the nip of a pair of rollers, view from below

FIGS. 2a-2b Schematic representations of embodiments of the mill according to the invention, side views in section

### DETAILED DESCRIPTION OF THE INVENTION

The figures show possible embodiments, which are explained in the following description.

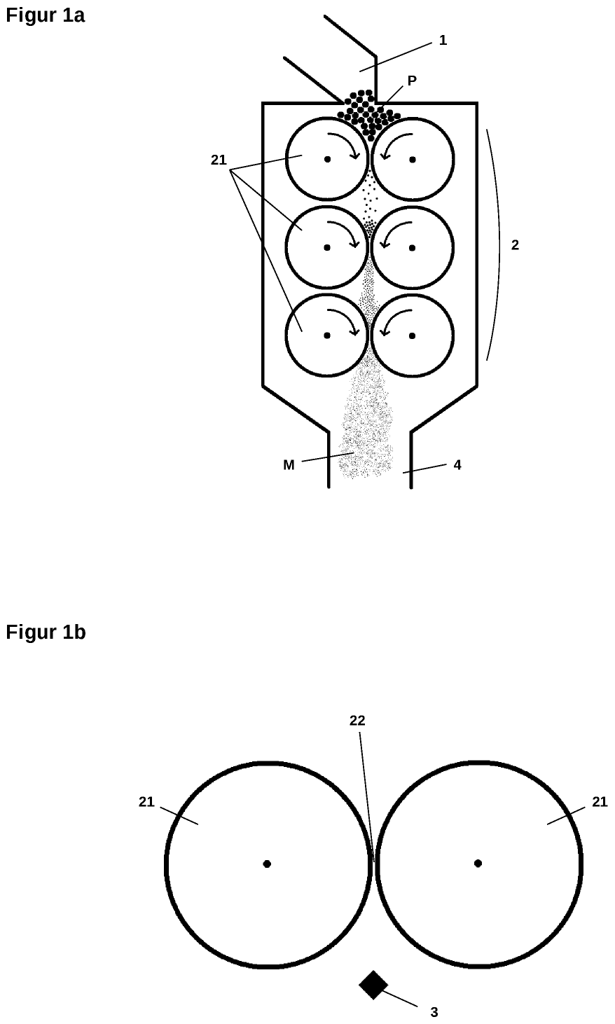

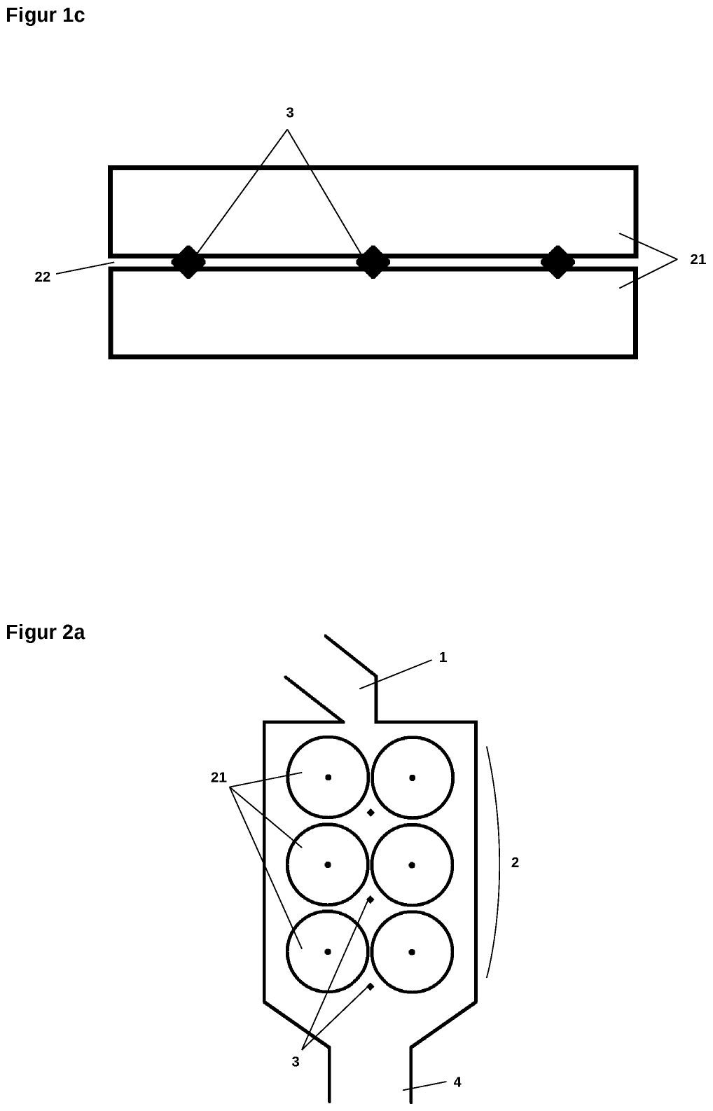

In the simplest embodiment of the invention, the autonomous mill comprises an inlet 1 for products P to be ground, at least one milling mechanism 2, an outlet 3 for the material to be ground M, at least one particle measuring probe 4, a control unit and means for adjusting the milling mechanism 2 (FIGS. 1a-b). The at least one particle measuring probe 4 is arranged in the milling mechanism 2 or between the milling mechanism 2 and the outlet 3 and regularly measures the sizes of the particles passing by it. The determined sizes are forwarded to the control unit, which uses these measured values to determine a size distribution. This information is used to control the means for adjusting the milling mechanism 2. The means for adjusting the milling mechanism 2 include, for example, drives with which the settings of the milling mechanism 2 can be changed. Preferably, a target value or reference value for the desired size distribution of the particles of the ground material M is stored in the control unit and the measured size distribution of the particles is compared with this information. If the determined size distribution does not match the desired value, the settings of the milling mechanism 2 are adjusted accordingly. The information for adjusting the settings is either stored as prede-fined values or as empirical values depending on the available measured values, or the settings are changed using the trial and error method until the desired particle size distribution is achieved. The size distribution of the ground particles is determined by the particle measuring probe 4 and the settings of the milling mechanism 2 are preferably adjusted continuously, automatically and in real time during the milling process. This control enables an immediate response to changes in particle size without manual or external intervention in order to ensure consistent out-put quality at all times.

In the preferred embodiment of the invention, the milling mechanism 2 comprises at least one pair of rollers 21 which are spaced apart with a certain roller gap 22 (FIG. 1b). During the milling process, the rollers 21 rotate against each other so that the product P to be ground is conveyed through the roller gap 22 and ground into smaller particles. The particle measuring probe 4 is posi-tioned after the pair of rollers 21 and determines the size distribution of the resulting particles. Since the size of the particles is an increasing function of the width of the roller gap 22, the width of the roller gap 22 is dynamically adjusted by the control unit depending on the measured size distribution of the ground particles: If the particles are too large, the rollers 21 are moved together and the roller gap 22 becomes narrower-if the particles are too small, the rollers 21 are moved apart and the roller gap 22 becomes wider. The means for adjusting the milling mechanism 2 are used to move the rollers 21 together and apart and are controlled by the control unit. To control the movement of the rollers 21 relative to each other and the width of the roller gap 22, a measuring unit can be provided which either directly measures the width of the roller gap 22 or the position of the axis of rotation of each roller 21.

Due to wear or contamination of the rollers, the width of the roller gap 22 along the rollers 21 may be uneven, resulting in a non-uniform particle size of the ground material M. In an advantageous embodiment of the invention, several particle measuring probes 4 are therefore arranged along the roller gap 22 (FIG. 1c). If excessive deviations in the particle size are detected by the particle measuring probes 4 along the roller gap 22, the means for adjusting the milling mechanism 2 can be used to automatically adjust the alignment of the rollers 21 relative to one another in order to correct the uneven roller gap 22.

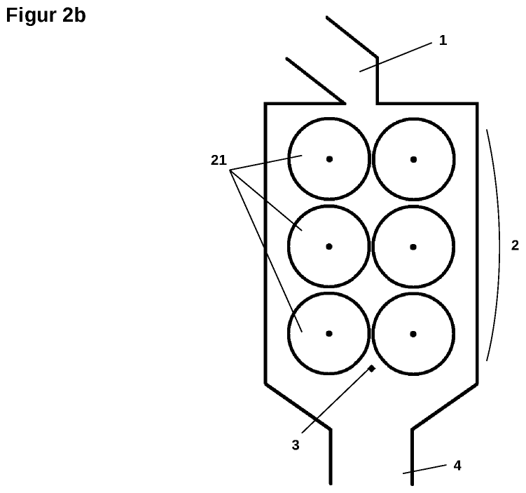

It is advantageous if the milling mechanism 2 has several pairs of rollers 21 through which the product P to be ground is ground several times and into increasingly finer particles (FIG. 1a). The several pairs of rollers can, for example, be arranged one after the other or one above the other so that the product to be ground passes from one pair of rollers to the next pair of rollers. In this case, the mill can be provided with a particle measuring probe 4 after each pair of rollers 21 to check the particle size and adjust each individual pair of rollers 21 (FIG. 2a). In a simple embodiment of the mill, a single particle measuring probe 4 can also be arranged after the last pair of rollers 21 or in the outlet 3 or between the milling mechanism 2 and the outlet 3 (FIG. 2b). It is to be expected that the ground end product M is already sufficiently mixed by the various pairs of rollers 21 or by conveyors arranged in between, so that this single particle measuring probe 4 can determine representative measurements.

In one possible embodiment, the mill is equipped with a suction device that can take particle samples alternately at several dif-ferent points of the milling mechanism 2 by means of particle removal devices and transport them to a single particle measuring probe 4. This makes it possible to check the particle size at several points of the milling mechanism 2 and to adjust each pair of rollers 21 without having to install several particle measuring probes 4 in the mill.

In addition to the particle size, other parameters that are relevant for the quality of the ground material M can also be measured and controlled during the milling process:
Temperature: The temperature of the products P to be ground can be monitored by means of a temperature probe in the inlet 1. If necessary, preconditioning of the products P to be ground can be provided in order to bring them to a certain temperature before they reach the milling unit 2. Preconditioning ensures that there is no quality-relevant deviation in the temperature of the material to be ground in milling mechanism 2. The temperature of the ground material can also be monitored during the milling process in milling unit 2 or in outlet 3. Controlled heating or cooling means can be provided to maintain the temperature of the ground material around a predetermined target value. The same naturally also applies to the ambient temperature, which should also be kept as uniform as possible.
Pressure in milling mechanism 2: The pressure in milling mechanism 2 can vary depending on the product P being pro-cessed and can increase during the milling process if out-gassing of the ground material occurs. The pressure prevailing in the milling mechanism can therefore be monitored and a controlled air extraction system or an external air supply can ensure constant pressure conditions around a predetermined target value.
Moisture: The moisture of the products P to be ground can be monitored by means of a moisture probe in the inlet 1. If necessary, the products P to be ground can be preconditioned in order to bring them to a certain moisture content before they reach the milling mechanism 2. Preconditioning ensures that there is no quality-relevant deviation in the moisture of the material to be ground in milling mechanism 2. The moisture of the material to be ground can also be monitored during the milling process in milling unit 2 or in outlet 3. Controlled humidifying or drying agents can be provided to maintain the moisture of the ground material around a predetermined target value. The humidity inside and outside the mill can also be controlled accordingly and kept as stable as possible.

In advantageous embodiments of the mill, parameters that provide information on the performance of the mill are also monitored:
Power consumption of the roller motors: If the power consumption of a roller motor changes while the product remains the same, it can be assumed that the roller 21 is dirty or worn because the frictional force increases.
Vibrations and roller temperature: If the vibrations or the temperature of the rollers or the temperature of the roller coolant fluid change slowly and steadily for the same product, it can be assumed that the product quality is poor or the rollers are dirty. Heating is usually due to poorer heat dissipation caused by dirt.

By monitoring one or more of these parameters, defects can be recognised at an early stage and the necessary repair of the milling mechanism 2 can be planned in good time or the ideal time to clean or replace the rollers can be calculated.

Soiling of the rollers can be compensated for to a certain extent by the roller gap regulation. Wear or soiling can lead to a gradual change in the setpoint value. Such changes are recognised by the system and stored as new set values in the control unit immediately after the end of the process.

In one embodiment of the invention, the mill is provided with an automatic roller cleaning system which is automatically activated and controlled by the control unit when contamination of the rollers 21 is detected.

At certain times, however, the rollers must be cleaned or replaced. To do this, the rollers must be removed, cleaned or replaced and reinstalled. The distances between the rollers are then re-refer-enced. Ideally, the reference setting can be based on an empirical value after the rollers have been cleaned or replaced. In certain cases. In certain cases, the rollers must be recalibrated with a test run. After maintenance or cleaning has been carried out on the system, the original reference values are restored.

According to the invention, it is envisaged that a recipe is sum-marised before the milling process, in which one or more of the above-mentioned parameters, including at least the desired size distribution of the ground particles, are defined as a target value. It is advantageous if recipe-specific tolerances are defined for each parameter in addition to the target value. During the milling process, these parameters are measured and compared by the control unit with the defined target value according to the recipe. If all measured values are within the desired range, it can be assumed that the ground material M is produced with the desired and consistent quality. If the measured values do not correspond to the specified target values, the settings of the milling mechanism 2 are adjusted by the control unit using the means for adjusting the milling mechanism 2. The determination of the size distribution of the ground particles by the particle measuring probe 4 and the corresponding adjustment of the settings of the milling mechanism 2 is preferably carried out continuously, automatically and in real time during the milling process.

In an advantageous embodiment, the mill outputs a signal during the milling process that contains the measured values or triggers an alarm if the measured values do not correspond to the desired target values. This signal can, for example, be a visual signal that is displayed on a screen. This signal can also be acoustic, especially if it serves as an alarm. The signal can also be electrical or electromagnetic and sent by cable or wirelessly to a separate electronic device, such as a central control unit. To enter the parameters to be monitored and the corresponding setpoints and tolerances, the mill can be provided with a user in-terface and/or it can receive an electrical or electromagnetic signal from a separate electronic device containing the parameters, setpoints and tolerances.

It is advantageous if some or all of the values measured during the milling process are stored in a database and made available for further processing. The collected data can be used to analyse processes retrospectively or live at any time. This enables seam-less process monitoring and control, as well as more precise def-inition of target values.

It is advantageous if the products P to be ground are either pre-weighed and dosed or the inlet 1 can be equipped with an inline quantity measurement.

To summarise, a new mill and a new milling process are presented that offer considerable advantages over the state of the art:
The mill works practically without human intervention.
All deviations in the quality-relevant process parameters are recognised immediately and rectified or reported directly;
The particle size is measured in a closed system, without losses or risks due to unnecessary sampling;
The mill ensures consistent quality thanks to immediate cor-rection of the quality-relevant parameters in the event of deviation from the specified target value. This means that even natural products can be ground in a controlled and consistent manner;
Downtimes during the process are virtually eliminated thanks to the numerous monitoring systems and data points;
The mill can be equipped with artificial intelligence that uses machine learning to anticipate maintenance requirements based on the measured parameters and plan them at the ideal time.

1-10. (canceled)

11. A mill comprising an inlet for products to be ground, at least one milling mechanism, an outlet for the ground material, at least one particle measuring probe for determining the sizes of the particles passing therethrough, a control unit and means for adjusting the milling mechanism,
wherein the at least one particle measuring probe or a particle extraction device, which is connected to the particle measuring probe via an extraction device, is arranged in the milling mechanism or between the milling mechanism and the outlet, and
the control unit is suitable for controlling the means for adjusting the milling mechanism on the basis of information from the at least one particle measuring probe.

12. The mill according to claim 11, wherein a desired value for the desired size distribution of the particles of the ground material is stored in the control unit and the control unit is suitable for comparing the measured size distribution of the particles with this desired value.

13. The mill according to claim 11, wherein the milling mechanism comprises at least one pair of rollers spaced apart by a roller gap.

14. The mill according to claim 13, wherein several particle measuring probes are arranged along the roller gap.

15. The mill according to claim 13, wherein the milling mechanism has several pairs of rollers.

16. The mill according to claim 15, wherein the mill has a single particle measuring probe, which is arranged after the last pair of rollers or in the outlet or between the milling mechanism and the outlet.

17. The mill according to claim 11, wherein the mill has several particle extraction devices at several points of the milling mechanism, wherein particle samples can be removed alternately at these several points of the milling mechanism by the extraction device and can be conveyed to a single particle measuring probe.

18. A milling method with the mill according to claim 11, comprising the following process steps:
first, a recipe is summarized in which at least the desired size distribution of the particles of the ground material is defined as the target value;
during the milling process, the size distribution of the particles of the ground material is measured and compared by the control unit with the defined target value according to the recipe;
if the measured particle size distribution of the ground material does not correspond to the defined target value, the settings of the milling mechanism are adjusted by the control unit using the means for adjusting the milling mechanism.

19. The milling method according to claim 18, wherein:
the recipe contains, in addition to a target value for the size distribution of the particles, target values for one or more of the following parameters: ambient temperature; temperature of the products to be ground; temperature of the ground material; moisture of the products to be ground; moisture of the ground material; humidity; pressure in the milling mechanism; power consumption of the roller motors; vibrations of the milling mechanism; temperature of the rollers;
during the milling process, one or more of these parameters are measured and compared by the control unit with the defined target value according to the recipe.

20. The milling method according to claim 19, wherein contamination or a defect in the milling mechanism is detected by monitoring ate least one of the power consumption of the roller motors, the vibrations of the milling mechanism and the temperature of the rollers.
